(19) United States
(12) Patent Application Publication
(10) Pub. No.: US 2007/0192847 A1
(43) Pub. Date: Aug. 16, 2007

(54) Dynamic network security system and control method thereof

(76) Inventor: Eung-Moon Yeom, Suwon-si (KR)

Correspondence Address: Robert E. Bushnell, Suite 300, 1522 K Street, N.W., Washington, DC, 20005-1202, US

(21) Appl. No.: 11/646,496

(22) Filed: Dec. 28, 2006

(30) Foreign Application Priority Data
Feb. 3, 2006 (KR) 10-2006-0010880

(51) Int. Cl. G06F 15/16

(52) U.S. Cl. 726/12

(57) ABSTRACT

A dynamic network security system and control method thereof dynamically judges application of a firewall in a router where firewall and VoIP ALG functions are integrated. A VoIP ALG for seamless VoIP service dynamically shares information (e.g., IP, port) on a VoIP media packet with the firewall, and thus when the VoIP media packet ingress a firewall intranet, firewall application on the VoIP media packet is intelligently processed. Unlike conventional methods set to statically apply firewall rule to particular IP and port, the firewall rule can be applied to or relieved from particular IP and port in real-time, and thus firewall policy can be operated more securely.

### CLAIM OF PRIORITY

This application makes reference to, incorporates the same herein, and claims all benefits accruing under 35 U.S.C.§ 119 from an application for SYSTEM AND METHOD FOR DYNAMIC NETWORK SECURITY earlier filed in the Korean Intellectual Property Office on 3 Feb. 2006 and there duly assigned Serial No. 10-2006-0010880.

### BACKGROUND OF THE INVENTION

1. Field of the Invention

The present invention relates to a dynamic network security system and a control method thereof.

2. Description of the Related Art

Security is one of the most important problems in the network nowadays. Various systems and methods are being used for network security. Firewall is also one of such network security systems. The firewall is located at a point where an organization supported thereby is connected to a network, protecting the organization from external attacks. In addition, the firewall is used to enable a host in the organization to access only specific services in the Internet. In case of network access without the firewall, all hosts are under the risk of external attacks.

The firewall is constructed by several methods, and in case of IP (Internet protocol) technology, packet filtering is generally used.

The packet filtering means a method to make a judgment whether to allow or not passage of a packet. That is, according to the packet filtering, a firewall is set to allow passage to only a specific packet in order to avoid any external attack. The firewall of the packet filtering, upon receiving a packet, makes a judgment on passage of the packet, and based on the judgment, allows or disallows passage of the received packet. The firewall judges whether or not to allow passage of the packet based on several informations of the packet such as IP address/port number information.

The firewall stores a predefined firewall rule list, and operates according to the firewall rule list in order to judge whether or not to allow passage of received packets. Upon receiving a packet, the firewall judges whether or not to allow passage of the packet with reference to the firewall rule list, and based on a judgment result, allows or disallows passage of the packet. Therefore, in case that a packet is desired to pass through the firewall, it should be registered previously in the firewall rule list. The firewall rule list may include packet information such as an IP address, a port number and a protocol.

Current networks support Voice over Internet Protocol (VoIP) packets, and the quantity of VoIP packets in use is increasing gradually. The VoIP packets, however, use a dynamic IP address and port. The firewall acts on a packet using the dynamic IP and port as follows.

If a received packet does not use a well-known port, there is no way to judge whether or not to apply the firewall to dynamic IP addresses and ports. Therefore, IP address and port ranges to be used should be set previously in the firewall rule list. That is, the IP address and port should be set beforehand so that packets of corresponding a IP address and port can pass through the firewall.

Furthermore, the firewall is conditional to VoIP services in a network environment that uses Private IP address. A VoIP service needs an Application Level Gateway (ALG) in order to use a private IP, and should use a public IP if ALG is not available. Of course, VoIP services using private IP and public IP need corresponding IP address, a port and so on opened in the firewall.

However, in case of packets using a dynamic IP address and port, a predetermined IP address and port are excluded always from the application of the firewall rule. This as a result disables reliable firewall construction.

### SUMMARY OF THE INVENTION

It is an object of the present invention to provide a dynamic network security system and a control method thereof, which is used in an all-in one system where firewall and VoIP functions are integrated, and designed to, through interworking with a firewall, share input VoIP RTP (Real-Time Transport Protocol) IP/port information recognizable through VoIP signaling in order to differentially process a VoIP packet by exempting it from firewall rule, thereby ensuring QoS (quality of service) on the security of the firewall.

It is another object of the invention to provide a dynamic network security system and a control method thereof, which can temporarily exempt firewall rule application on dynamic IP and port in a VoIP service rather than performing conventional methods in which a firewall operator designates coverage of a firewall about IP/port/protocol about VoIP service packets, thereby to overcome restriction of firewall rule application.

It is yet another object of the invention to provide a dynamic network security system and a control method thereof, which can provide interworking through integration of application technologies for ensuring security QoS in a router where firewall and VoIP ALG functions are integrated.

It is yet another object of the invention to provide a dynamic network security system and a control method thereof, which can run a VoIP system vendor-independently in a router where firewall and VoIP ALG functions are included.

One aspect of the present invention is to provide an integrated switching system including a router and a switching unit, wherein the router comprises: a firewall for storing communication information on a counterpart unit in an Access Control List (ACL) and for allowing or disallowing passage of a packet received from the counterpart unit according to the communication information stored in the ACL; and a signaling processor for transmitting the communication information acquired through signaling with the counterpart unit to the firewall.

The signaling processor is adapted to acquire the communication information through VoIP signaling with the counterpart unit and to provide the acquired communication information to the firewall, wherein the communication information is one selected from the group IP information, port information and protocol information of the counterpart unit that performs VoIP signaling with a VoIP ALG. Here, the VoIP ALG is adapted to provide the acquired IP/port/protocol information to the firewall according to predefined protocol, wherein the predefined protocol is Inter Processor Communication (IPC) protocol.

The VoIP ALG is adapted to, when VoIP communication with the counterpart unit is terminated, to provide a message including the IP/port/protocol information of the counterpart unit to the firewall to disallow passage of a packet received from the counterpart unit.

The firewall includes: a firewall rule memory for storing the IP/port/protocol information for the counterpart unit in the ACL; and a packet processor for acquiring the IP/port/protocol information of the counterpart unit from the VoIP ALG to store in the ACL of the firewall rule memory and for allowing or disallowing passage of the received packet to the switching unit according to the IP/port/protocol information stored in the ACL of the firewall rule memory.

Another aspect of the present invention is to provide a router in an integrated switching system, the system including: a VoIP ALG for acquiring IP/port/protocol information of a counterpart unit through VoIP signaling with the counterpart unit, the IP/port/protocol information used for judging whether or not to allow passage of a packet to a switching unit; a firewall rule memory for storing the IP/port/protocol information in an ACL; and an IP/port/protocol processor for storing the IP/port/protocol information acquired from the VoIP ALG into the ACL of the firewall rule memory and for allowing or disallowing passage of the received packet to the switching unit according to the IP/port/protocol information stored in the ACL of the firewall rule memory.

Further another aspect of the present invention is to provide a method of processing a receiving packet in an integrated switching system including: a router and a switching unit, the method comprising steps of: at the router, acquiring communication information of a counterpart unit supposed to communicate with through signaling with the counterpart unit; storing the acquired communication information in an ACL; and allowing or disallowing passage of a received packet according to the communication information stored in the ACL

The communication information is one selected from the group IP information, port information and protocol information which are acquired through signaling with the counterpart unit.

Yet another aspect of the present invention is to provide a method of processing a receiving packet in an integrated switching system including a router and a switching unit, in which the router includes a VoIP ALG and a firewall, the method comprising steps of: at the VoIP ALG of the router, acquiring communication of a counterpart unit to communicate with through VoIP signaling with the counterpart unit, and providing the acquired communication information of the counterpart unit to the firewall; at the firewall, storing the communication information of the counterpart unit provided from the VoIP ALG in an ACL; and at the firewall, allowing or disallowing passage of a received packet according to the communication information stored in the ACL

The present invention as described below can be realized by using IP/port information. That is, according to certain embodiments of the invention, if it is judged that receipt of a VoIP packet starts through a specific port, packets received through such a port since then are allowed to pass through without packet pattern matching. After that, when it is judged that receipt of VoIP packets through the port is terminated, packets are disallowed to pass through the port.

The VoIP ALG in the router makes a judgment whether or not to allow passage to the received packet. The VoIP ALG, through signaling with a counterpart unit to communicate with, acquires communication information through which a packet is to be received, and provides the acquired communication information to the firewall through interworking. The firewall judges whether or not to allow passage of the received packet according to the IP/port information provided from the VoIP ALG.

Upon receiving the IP/port information from the VoIP ALG, the firewall allows passage of a packet received through corresponding IP/port. The firewall has an ACL for storing the IP/port information as a basis for judgment on passage of the received packet. The firewall updates the ACL whenever receiving communication information from the VoIP ALG through interworking. Thereby dynamic network security is enabled so that the firewall allows or disallows passage of the packet based on present communication conditions.

That is, according to certain embodiments of the invention, the firewall updates the ACL in real-time by reflecting the IP/port/protocol information provided from the VoIP ALG which interworks with the firewall in the router and acquires the IP/port/protocol through signaling. Referring to the ACL, the firewall judges whether or not to allow passage of the received packet, and according to a result of such judgment, allows or disallows the received packet to pass through.

If it is judged that VoIP communication via the port is terminated, the VoIP ALG of the router provides information including an instruction signal to the firewall, instructing the firewall to disallow passage of a packet received through the port with such port information. That is, when receipt of VoIP packets through the port with corresponding IP/port information is terminated, the VoIP ALG prohibits passage of packets received through the port. Here, the VoIP ALG can acquire such communication termination-related information through signaling with a counterpart unit which has been communicating with the VoIP ALG.

When the firewall is provided with passage disallowance information from the VoIP ALG, it updates corresponding information according to such information. Then, the firewall judges whether or not to allow passage of a received packet according to the updated ACL. That is, although packets have been received through a specific port, they are disallowed to pass through according to the ACL updated with such passage disallowance information.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a network including an all-in one switching system in which a router and a switching unit are integrated according to the invention;

FIG. 2 is a detailed block diagram of the switching unit shown in FIG. 1;

FIG. 3 is a diagram illustrating signal flows for packet security cooperative processing between a firewall system and a VoIP ALG in the router according to the invention; and

FIG. 4 is a process flowchart of a control method of dynamic network security according to the invention.

### DETAILED DESCRIPTION OF THE PREFERRED EMBODIMENTS

The present invention will now be described more fully hereinafter with reference to the accompanying drawings, in which preferred embodiments of a dynamic network security system and a control method thereof according to the invention are shown. In the following description of the invention, well-known functions or constructions will not be described in detail since they would unnecessarily obscure the intent of the invention.

In the following illustrative embodiments of the invention will be applied to IP packets that request real-time processing, in which VoIP packets will be used as an example of the IP packets that request real-time processing. However, this is illustrative only, but the invention is not limited thereto.

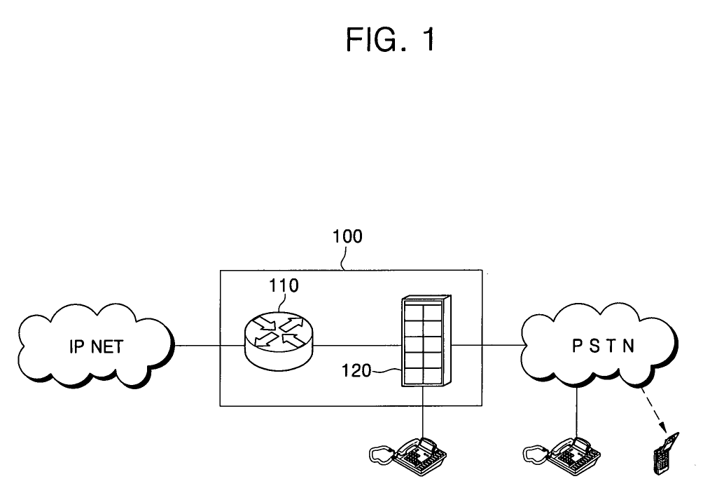

FIG. 1 is a block diagram of a network including an all-in one switching system in which a router and a switching unit are integrated according to the invention.

As shown in FIG. 1, an all-in one switching system 100 is provided to judge whether or not to screen received packets, allow or disallow passage of the packets according to a result of the judgment, and switch normal packets upon passage thereof.

A router 110 in FIG. 1 serves to open or close a port for network connection according predefined rules, and a switching unit 120 performs a switching function to transmit packets received to requested locations according to information on the packets.

In this disclosure of the invention, the switching unit 120 performs signaling with a counterpart unit, which a packet sender attempts to communicate with, and provides any information acquired through the signaling to the router 110.

The present invention may be applied to the network including the all-in one switching system 100 as shown in FIG. 1, or to a network where the router 110 and the switching unit 120 are independent from each other. First, the disclosure will be made of detailed internal structures and operations of the router 110 and the switching unit 120 in an embodiment where the router 110 and the switching unit 120 are applied to the network as shown in FIG. 1 which includes the all-in one switching system 100.

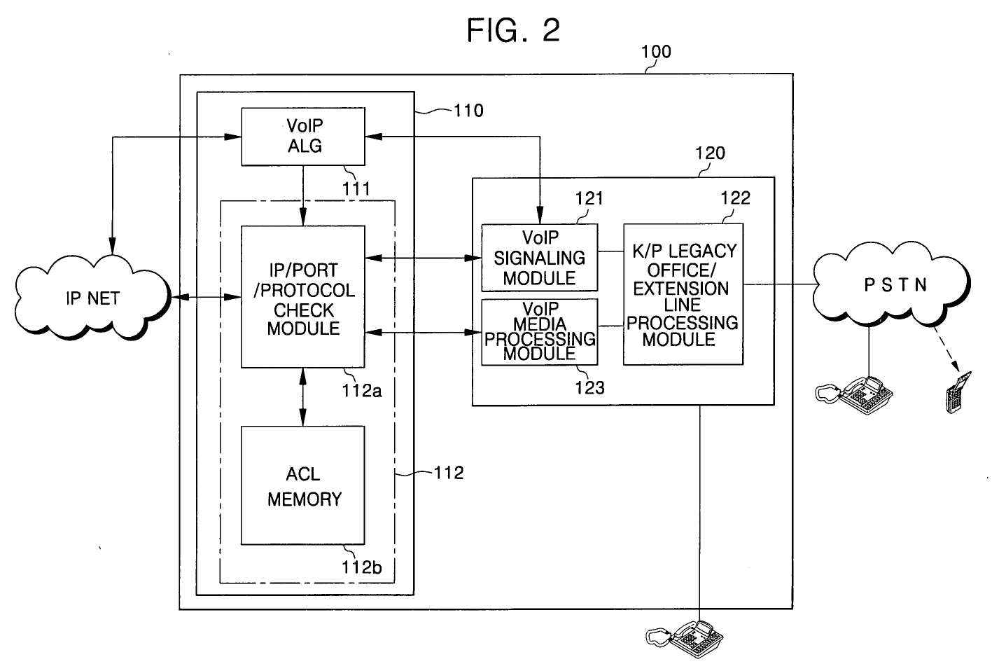

FIG. 2 is a detailed block diagram of the switching unit shown in FIG. 1.

As shown in FIG. 2, the switching unit 120 of the all-in one switching system 100 includes a VoIP signaling processing module 121, a VoIP media processing module 123 and a K/P legacy office/extension line processing module 122.

The router 110 includes a VoIP ALG (Application Level Gateway) 111 and a firewall 112, which in turn includes an IP/port/protocol check module 112a and a firewall rules (ACL: Access Control List) memory 112b.

The switching unit 120 performs a switching function to transmit received packets to requested destinations according to information included in the packets. The switching unit 120 in this disclosure of the invention also includes a function to provide communication information such as IP/port number/protocol information acquired through signaling to the router 110.

The VoIP signaling module 121 of the switching unit 120 performs signaling for VoIP calls.

In addition, the VoIP signaling module 121 can judge types of corresponding packets according to header information of received packets.

The VoIP media processing module 123 performs media transcoding for VoIP calls.

The office/extension line processing module 122 performs switching for packets.

Particularly, if a received packet is judged as a VoIP packet that requests real-time processing, the switching unit 120 provides communication information on this packet to the router 110 so that the firewall 112 of the router 110 allows passage of the packet when received via such port.

In general, one call is received through the same port from beginning to end. That is, a port which has received a VoIP packet can be understood as receiving this VoIP packet until a call including this packet is terminated. Therefore, when the VoIP packet is received, the switching unit 120 provides IP/port information on the VoIP packet to the router 110 so that the firewall 112 of the router 110 allows passage of the VoIP packet when received through such port.

Upon termination of a VoIP call, the switching unit 120 informs it to the firewall 112, thereby to cancel passage allowance of packets received through such port. When the firewall 112 receives information of canceling passage allowance on specific port from the switching unit 120, it disallows passage of packets received through such port since then.

The information that the switching unit 120 provides to the router 110 may include IP information and port information of a port where the VoIP packets are received, protocol information, firewall passage allowance or cancellation information and so on.

Such information is generated by the VoIP signaling module 121 of the switching unit 120 and provided to the VoIP ALG 111 of the router 110, which in turn provides the received information to the IP/port/protocol check module 112a of the firewall 112.

This is because the VoIP signaling module 121 can confirm VoIP IP/port information. That is, the VoIP signaling module 121 confirms whether or not a received packet is a VoIP packet that requests real-time processing, and if the packet is a VoIP packet, provides the VoIP ALG 111 of the router 110 with IP/port information of the packet together with an instruction to allow passage of the packet received through such port. Then, the VoIP ALG 111 provides such information to the IP/port/protocol check module 112a of the firewall 112 interworking therewith.

Then, when a last packet of a corresponding call is received via such port, the VoIP signaling module 121 provides the VoIP ALG 111 of the router 110 with corresponding IP/port information together with instruction information, which instructs to cancel passage allowance on packets received through such port.

In this embodiment, the router 110 and the switching unit 120 are elements of the all-in one switching system 100. The switching unit 120 provides an instruction of firewall passage allowance or cancellation on VoIP packets to the VoIP ALG 111 of the router 110, and the VoIP ALG 111 can provides the instruction to the firewall 112.

The firewall 112 judges whether to allow or disallow passage of a received packet based on the information from the VoIP ALG 111.

The IP/port/protocol check module 112a of the firewall 112 judges whether allow or disallow passage of a received packet, and according to a result of the judgment, allows or disallows passage of the received packet. The IP/port/protocol check module 112a makes such judgment on a received packet with reference to firewall rules or ACL stored in the ACL memory 112b. In addition, when the VoIP ALG 111 provides an instruction of passage allowance or cancellation on packets, the IP/port/protocol check module 112a outputs such information to the ACL memory 112b.

The ACL or firewall rules stored in the ACL memory 112b are updated in real-time according to information/instruction inputted from the IP/port check module 112a.

Therefore, the firewall 112 judges whether to allow or disallow passage of a received packet according to afore-mentioned ACL. Through this process, this embodiment of the invention enables dynamic network security using firewall that reflects present communication status.

According to the afore-described embodiment, the VoIP signaling module 121 of the switching unit 120 acquires IP/port information for allowing/disallowing passage of received packets through signaling, and provides the acquired information to the VoIP ALG 111 of the router 110. The VoIP ALG 111 provides the IP/port information received from the VoIP signaling module 121 to the firewall 112 to allow/disallow passage of received packets. However, the IP/port information for allowing/disallowing passage of received packets may be acquired from the VoIP ALG 111 of the router 110, and packet processing using the acquired information may be carried out through interworking with the firewall. Operations of such an embodiment will be described as follows.

The VoIP ALG 111 of the router 110 shown in FIG. 2 is a module for solving IP traversal problem, and serves to translate IP/port information in payload of VoIP protocol into NAT-PT (Network Address Translation—Protocol Translation) rules.

Accordingly, the VoIP ALG 111 performs trans-VoIP call signaling and media transcoding on the IP/port information. In ALG processing of VoIP signaling, the VoIP ALG 111 scans dynamic RTP IP/port information in a signaling message. Then, in call setup, the IP/port/protocol check module 112a transmits such IP/port information to an ACL of the ACL memory 112b to perform “Open” processing. In VoIP call release, the IP/port/protocol check module 112a transmits corresponding RTP IP/port information to the ACL to perform “Close” processing.

By interworking with the IP/port/protocol check module 112a on dynamic VoIP RTP IP/port information, the VoIP ALG 111 provides corresponding VoIP IP, port and protocol information to dynamically allow/disallow packet receipt, thereby enabling security QoS.

The ACL memory 112b of the firewall 112 processes corresponding IP/port/protocol firewall rule in the ACL including firewall rules according to IP/port/protocol information. That is, upon receiving IP/port information from the VoIP ALG 111 interworking with the IP/port/protocol check module 112a, the ACL memory 112b updates such IP/port information in the ACL so that the IP/port information is stored and managed therein. Then, by using the updated ACL, the IP/port/protocol check module 112a can allow/disallow receipt of packets.

The IP/port/protocol check module 112a of the firewall 112 interworks with the VoIP ALG 111 in the router 110, and compares dynamic IP/port/protocol information provided from the VoIP ALG 111 with a received IP packet to judge whether or not apply the ACL stored in the ACL memory 112b to the packet.

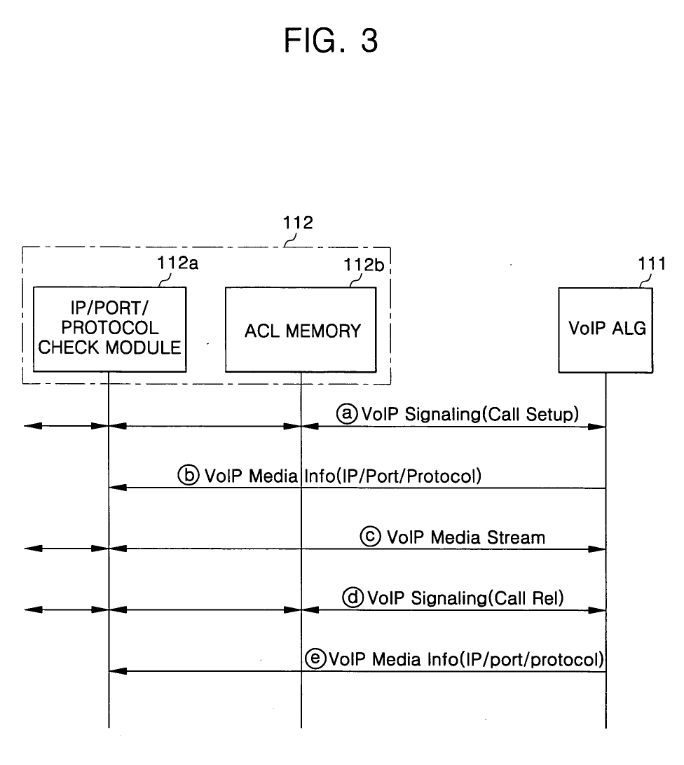

Now, with reference to FIG. 3, a stepwise security process using such a structure will be described in detail.

FIG. 3 is a diagram illustrating signal flows for packet security cooperative processing between a firewall system and a VoIP ALG in the router according to the invention.

As shown in FIG. 3, \textcircled{a} indicates a VoIP signaling flow for VoIP call setup. First, the VoIP ALG 111 can perform VoIP signaling with a counterpart unit of a corresponding VoIP call through the IP/port check module 112a and a network (e.g., an IP network). For this process, a VoIP signaling signal (see the reference signal \textcircled{a}) using a VoIP call setup message can be used. The VoIP signaling in the VoIP ALG 111 begins with a well-known port (e.g., H.323 TCP 1719,1720 Port and SIP UDP 5060 Port).

When the VoIP ALG 111 checks IP/port/protocol information of the counterpart unit through the VoIP signaling, a well-known port (e.g., H.323 TCP 1719,1720 Port and SIP UDP 5060 Port) is previously released in case of an ingress process by the IP/port check module 112a of the firewall 112 so that the VoIP ALG 111 can process the VoIP signaling using the well-known port.

As a result, the VoIP ALG 111 acquires IP/port/protocol information of the counterpart unit according to the VoIP signaling using the VoIP call setup message.

Second signal flow \textcircled{b} is a process of instructing the IP/port check module 112a of the firewall 112 to allow passage of a packet to the switching unit 120 if it is received from a source unit having the IP/port information acquired through the VoIP signaling.

The VoIP ALG 111 acquires RTP media information or IP/port/protocol information when regenerating a signaling payload according to NAT/PT rule of the VoIP call setup message (e.g., Q931 “Setup” message or SIP “INVITE” message) after signaling-scanning with the counterpart unit, and then transmits it to the IP/port/protocol check module 112a of the firewall 111, notifying of local VoIP service information.

Upon receiving the IP/port/protocol information for packet receipt allowance/disallowance provided from the VoIP ALG 111, the IP/port check module 112a of the firewall 112 sets the received IP/port/protocol information to be exempted from firewall rule application. That is, the IP/port/protocol information for packet receipt allowance/disallowance is updated in the ACL of the ACL memory 112b of the firewall 112 so that the information is stored and managed therein.

Therefore, in signal flow \textcircled{c} shown in FIG. 3, the IP/port/protocol check module 112a of the firewall 112 checks the ACL stored in the ACL memory 112b in order to relieve VoIP media stream packets from firewall rule application when the packet is received from a source unit having such IP/port/protocol information. That is, the IP/port/protocol check module 112a checks the ACL stored in the ACL memory 112b in order to pass a packet to the switching unit 120 without application of firewall rule if the packet is received from a source unit having such IP/port/protocol information.

When a VoIP call with the source unit having such IP/port/protocol information is terminated, and a VoIP call release message (e.g., Q931 “Disconnect” message or SIP “BYE” message) is received (indicated with signal flow \textcircled{d} in FIG. 3), the VoIP ALG 111 forwards corresponding RTP IP/Port/Protocol information of the call release message to the IP/Port/Protocol check module 112a in the firewall 112 (indicated with signal flow \textcircled{e} in FIG. 3).

Therefore, the IP/Port/Protocol check module 112a of the firewall 112a deletes the RTP IP/Port/Protocol information of the received call release message from the ACL memory 112b. Since then, the IP/Port/Protocol check module 112a disallows passage of a received packet if the packet has such information.

Now the operation of the dynamic network security system of the invention will be summarized as follows.

First, in an IP network where the firewall 112 and the VoIP ALG 111 are integrated in the router as shown in FIG. 2, when the router 110 receives an IP packet, the IP/port/protocol check module 112a of the firewall 112 judges whether or not to apply firewall rule (e.g., blocking scheme and allowance time) to the received IP packet, by using IP/port/protocol information of the packet. If the packet is judged as one subject to firewall rule application, the IP/port/protocol check module 112a confirms and applies a firewall rule about the IP/port/protocol information.

In general, a firewall is established in such a method that all of packets subject to ingress to the intranet are blocked but particular services (e.g., FTP, Telnet and SMTP) are exempted from firewall screening.

In order to provide VoIP service, VoIP signaling port for VoIP signaling should be exempted from firewall rule application.

When a VoIP signaling message is received through an opened VoIP signaling port in a firewall, the VoIP ALG 111 in the router 110 performs parsing and judgment on VoIP call setup and release according to the VoIP signaling message to transmit RTP IP, port and protocol of a VoIP media processor (not shown) inside the VoIP ALG 111 to the IP/port/protocol check module 112a. Such RTP IP, port and protocol is determined for actual media transmission through VoIP call setup signaling between the VoIP media processor (not shown) inside the VoIP ALG 111 and a remote VoIP system. Then the firewall 112 opens corresponding VoIP media packets to ingress the intranet during VoIP service.

Upon termination of VoIP service, the VoIP ALG 111 transmits IP/port/protocol information of an internal transcoding system associated with the terminated VoIP service to the IP/port/protocol check module 112a of the firewall 112 so that firewall rule is applied again. Here, the IP/port/protocol check module 112 should delete the received IP/port/protocol information from the ACL list so that the firewall rule can be applied again.

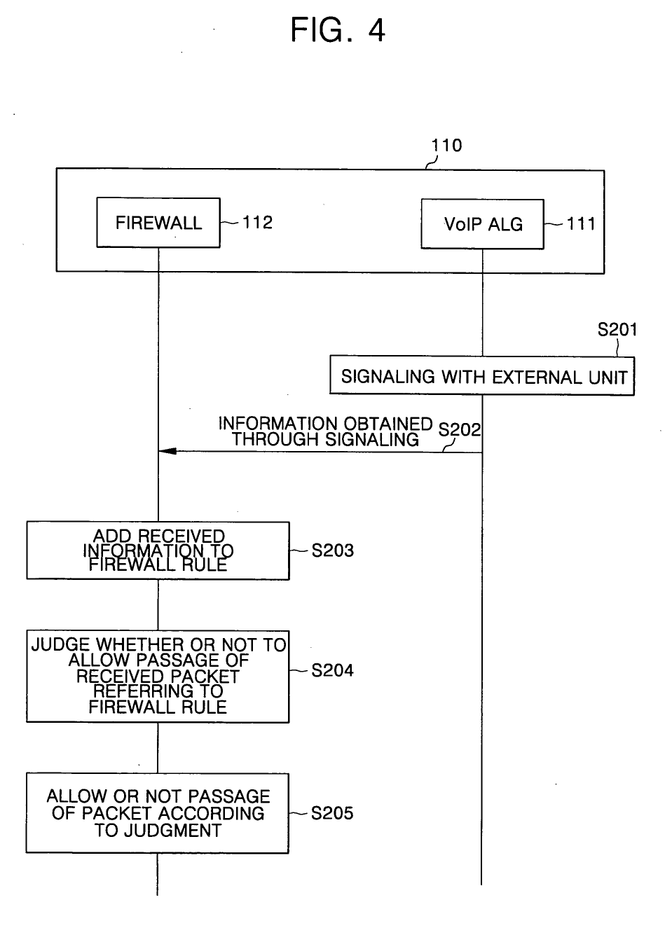

Stepwise description will now be made of a dynamic network security control method of the invention with reference to FIG. 4.

FIG. 4 is a process flowchart of a control method of dynamic network security according to the invention.

As shown in FIG. 4, the VoIP ALG 111 in the router 110 can perform VoIP signaling with an external unit by using a VoIP call setup message, and through the VoIP signaling, acquires IP/port/protocol information of the counterpart unit in S201.

The VoIP ALG 111 in the router 110, upon acquiring the IP/port/protocol information through the VoIP signaling, provides the IP/port/protocol information of the source unit to the IP/port/protocol check module 112a of the firewall 112 in order to instruct the IP/port/protocol check module 112a to allow passage of packets when received from the source unit having the IP/port/protocol information in S202. That is, the VoIP ALG 111 acquires RTP media information or IP/port/protocol information when regenerating a signaling payload according to NAT/PT rule of the VoIP call setup message (e.g., Q931 “Setup” message or SIP “INVITE” message) after signaling-scanning with the counterpart unit, and then transmits it to the IP/port/protocol check module 112a of the firewall 111, notifying of local VoIP service information.

In S203, upon receiving the IP/port/protocol information for packet receipt allowance/disallowance provided from the VoIP ALG 111, the IP/port/protocol check module 112a additionally updates the received IP/port/protocol information in the ACL of the ACL memory 112b.

In S204, the IP/port/protocol check module 112a of the firewall 112 judges whether to allow/disallow passage of received packets with reference to the ACL stored in the ACL memory 112b.

Then, according to a result of the judgment, the IP/port/protocol check module 112a of the firewall 112 allows or disallows passage of the received packets in S205.

That is, the IP/port/protocol check module 112a checks the ACL stored in the ACL memory 112b to relieve VoIP media packets from firewall rule application when the packets are received from the source unit having the IP/port/protocol information. More particularly, the IP/port/protocol check module 112a checks the ACL stored in the ACL memory 112b to acquire the IP/port/protocol information received from the VoIP ALG 111, and when packets are received from the source unit having the IP/port/protocol information, allows the packets to pass to the switching unit 120.

With the VoIP call with the source unit having such IP/port/protocol information terminated, when a VoIP call release message (e.g., Q931 “Disconnect” message or SIP “BYE” message) is received, the VoIP ALG 111 forwards corresponding RTP IP/Port/Protocol information of the call release message to the IP/Port/Protocol check module 112a in the firewall 112.

Therefore, the IP/Port/Protocol check module 112a of the firewall 112a deletes the RTP IP/Port/Protocol information of the received call release message from the ACL memory 112b. Since then, the IP/Port/Protocol check module 112a disallows passage of a packet received with such information.

As set forth above, the dynamic network security system and control method thereof according to the invention dynamically judges application of a firewall in a router where firewall and VoIP ALG functions are integrated. A VoIP ALG for seamless VoIP service dynamically shares information (e.g., IP, port) on a VoIP media packet with the firewall, and thus when the VoIP media packet ingress a firewall intranet, firewall application on the VoIP media packet is intelligently processed. Unlike conventional methods set to statically apply firewall rule to particular IP and port, the firewall rule can be applied to or relieved from particular IP and port in real-time, and thus firewall policy can be operated more securely.

Furthermore, the VoIP ALG function is operated in a real-time data transmission application where a well-known port of RTP data for VoIP media data is not used in order to ensure firewall QoS.

As a result, in an all-in one system where the firewall and VoIP ALG functions are integrated, different internal modules share information on VoIP using dynamic IP/port through interworking at start-up and termination of a VoIP service. This can solve security QoS problem occurring in conventional firewall systems which statically open IP/port for VoIP service, thereby providing convenience in operation and setting.

While the present invention has been shown and described in connection with the preferred embodiments, it will be apparent to those skilled in the art that modifications and variations can be made without departing from the spirit and scope of the invention as defined by the appended claims.

For example, while the preferred embodiments have been described above as for a system where the router and the switching system are integrated, those skilled in the art can apply such embodiments in substantially the same fashion to networks where a router and a switching unit exist separately rather than integrated.

In addition, while VoIP packets have illustrated so far, it will be also apparent to those skilled in the art that the scope of the invention is not limited to the VoIP packet but can embrace all packets using dynamic IP and port.

What is claimed is:

1. An integrated switching system including a router and a switching unit, wherein the router comprises:
a firewall for storing communication information on a counterpart unit in an Access Control List (ACL) and for allowing or disallowing passage of a packet received from the counterpart unit according to the communication information stored in the Access Control List (ACL); and
a signaling processor for transmitting the communication information acquired through signaling with the counterpart unit to the firewall.

2. The integrated switching system according to claim 1, wherein the signaling processor is adapted to acquire the communication information through VoIP signaling with the counterpart unit and to provide the acquired communication information to the firewall.

3. The integrated switching system according to claim 2, wherein the communication information is one selected from the group IP information, port information and protocol information of the counterpart unit that performs Voice over Internet Protocol (VoIP) signaling with a VoIP Application Level Gateway (ALG).

4. The integrated switching system according to claim 3, wherein the VoIP ALG is adapted to provide the acquired IP/port/protocol information to the firewall according to predefined protocol.

5. The integrated switching system according to claim 4, wherein the predefined protocol is Inter Processor Communication (IPC) protocol.

6. The integrated switching system according to claim 4, wherein the VoIP ALG is adapted to, when VoIP communication with the counterpart unit is terminated, to provide a message including the IP/port/protocol information of the counterpart unit to the firewall to disallow passage of a packet received from the counterpart unit.

7. The integrated switching system according to claim 6, wherein the firewall includes:
a firewall rule memory for storing the IP/port/protocol information for the counterpart unit in the Access Control List (ACL); and
a packet processor for acquiring the IP/port/protocol information of the counterpart unit from the VoIP ALG to store in the Access Control List (ACL) of the firewall rule memory and for allowing or disallowing passage of the received packet to the switching unit according to the IP/port/protocol information stored in the Access Control List (ACL) of the firewall rule memory.

8. A router in an integrated switching system comprising:
a Voice over Internet Protocol Application Level Gateway (VoIP ALG) for acquiring IP/port/protocol information of a counterpart unit through VoIP signaling with the counterpart unit, the IP/port/protocol information used for judging whether or not to allow passage of a packet to a switching unit;
a firewall rule memory for storing the IP/port/protocol information in an Access Control List (ACL); and
an IP/port/protocol processor for storing the IP/port/protocol information acquired from the VoIP ALG into the Access Control List (ACL) of the firewall rule memory and for allowing or disallowing passage of the received packet to the switching unit according to the IP/port/protocol information stored in the Access Control List (ACL) of the firewall rule memory.

9. A method of processing a receiving packet in an integrated switching system including a router and a switching unit, the method comprising steps of:
at the router, acquiring communication information of a counterpart unit supposed to communicate with through signaling with the counterpart unit;
storing the acquired communication information in an Access Control List (ACL); and
allowing or disallowing passage of a received packet according to the communication information stored in the Access Control List (ACL).

10. The method according to claim 9, wherein the communication information is one selected from the group IP information, port information and protocol information which are acquired through signaling with the counterpart unit.

11. A method of processing a receiving packet in an integrated switching system including a router and a switching unit, in which the router includes a Voice over Internet Protocol Application Level Gateway (VoIP ALG) and a firewall, the method comprising steps of:
at the VoIP ALG of the router, acquiring communication of a counterpart unit to communicate with through VoIP signaling with the counterpart unit, and providing the acquired communication information of the counterpart unit to the firewall;
at the firewall, storing the communication information of the counterpart unit provided from the VoIP ALG in an Access Control List (ACL); and
at the firewall, allowing or disallowing passage of a received packet according to the communication information stored in the Access Control List (ACL).

12. The method according to claim 11, wherein the communication information is one selected from the group IP information, port information and protocol information.

13. The method according to claim 12, wherein the VoIP ALG provides the acquired IP/port/protocol information to the firewall according to predefined protocol.

14. The method according to claim 13, wherein the predefined protocol is Inter Processor Communication (IPC) protocol.

15. The method according to claim 13, wherein when VoIP communication with the counterpart unit is terminated, the VoIP ALG provides a message including the IP/port/protocol information of the counterpart unit to the firewall to disallow passage of a packet received from the counterpart unit.
